(19) United States
(12) Patent Application Publication
(10) Pub. No.: US 2026/0145715 A1
(43) Pub. Date: May 28, 2026

(54) IDENTIFICATION DEVICE, IDENTIFICATION METHOD, AND NON-TRANSITORY COMPUTER-READABLE MEDIUM

(71) Applicant: NEC Corporation, Tokyo (JP)

(72) Inventors: Ryoto ITSUBO, Tokyo (JP); Koyo MORI, Tokyo (JP)

(73) Assignee: NEC Corporation, Tokyo (JP)

(21) Appl. No.: 19/369,587

(22) Filed: Oct. 27, 2025

(30) Foreign Application Priority Data
Nov. 27, 2024 (JP) 2024-206214

(51) Int. Cl. B61L 25/02; G01H 9/00

(52) U.S. Cl. CPC B61L 25/025; B61L 25/023; G01H 9/004

(57) ABSTRACT

An identification device according to the present disclosure includes at least one memory that stores instructions, and at least one processor configured to execute the instructions to receive backscattered light from an optical fiber laid in a vicinity of a plurality of first tracks along the plurality of first tracks in which a traveling direction of a train is a first direction, detect vibration at each position on the optical fiber based on the backscattered light, and identify, among the plurality of first tracks, a first track on which a train is traveling based on vibration at each position on the optical fiber.

### INCORPORATION BY REFERENCE

This application is based upon and claims the benefit of priority from Japanese patent application No. 2024-206214, filed on November 27, 2024, the disclosure of which is incorporated herein in its entirety by reference.

### TECHNICAL FIELD

The present disclosure relates to an identification device, an identification method, and a non-transitory computer-readable medium.

### BACKGROUND ART

Currently, as a method of identifying a traveling position of a train in a longitudinal direction of a track, there is a method of using a track circuit.

However, the method using the track circuit has a problem that the traveling position of the train can be grasped only in terms of points, and a problem that equipment is expensive because it is necessary to install a large number of track circuits.

On the other hand, recently, a technology called optical fiber sensing using an optical fiber as a sensor has been developed. In the optical fiber sensing, vibration generated at each position on an optical fiber can be detected. Therefore, by using the optical fiber sensing, the traveling position of the train can be continuously grasped on the surface at low cost.

For example, as a technique for identifying a traveling position of a train in a longitudinal direction of a track by optical fiber sensing, there is a technique disclosed in JP 2018-114790 A.

### SUMMARY

By the way, for example, in a case where the form of the track is a quadruple track, there are a plurality of tracks in which the traveling directions of the trains are the same.

However, the technique disclosed in JP 2018-114790 A described above has a problem that a track on which a train is traveling cannot be specified among a plurality of tracks as described above.

Therefore, in view of the above-described problems, an example object of the present disclosure is to provide an identification device, an identification method, and a non-transitory computer-readable medium capable of identifying a track on which a train is traveling among a plurality of tracks on which the traveling directions of the trains are the same.

An identification device according to an example aspect includes

at least one memory that stores instructions, and

at least one processor configured to execute the instructions to

receive backscattered light from an optical fiber laid in a vicinity of a plurality of first tracks along the plurality of first tracks in which a traveling direction of a train is a first direction,

detect vibration at each position on the optical fiber based on the backscattered light, and

identify, among the plurality of first tracks, a first track on which a train is traveling based on vibration at each position on the optical fiber.

An identification method according to an example aspect is an identification method executed by an identification device, the method including

receiving backscattered light from an optical fiber laid in a vicinity of a plurality of first tracks along the plurality of first tracks in which a traveling direction of a train is a first direction,

detecting vibration at each position on the optical fiber based on the backscattered light, and

identifying, among the plurality of first tracks, a first track on which a train is traveling based on vibration at each position on the optical fiber.

A non-transitory computer-readable medium according to an example aspect stores a program for causing a computer to execute

a step of receiving backscattered light from an optical fiber laid in a vicinity of a plurality of first tracks along the plurality of first tracks in which a traveling direction of a train is a first direction,

a step of detecting vibration at each position on the optical fiber based on the backscattered light, and

a step of identifying, among the plurality of first tracks, a first track on which a train is traveling based on vibration at each position on the optical fiber.

According to the above-described aspect, it is possible to provide an identification device, an identification method, and a non-transitory computer-readable medium capable of identifying a track on which a train is traveling among a plurality of tracks in which traveling directions of the trains are the same.

### BRIEF DESCRIPTION OF DRAWINGS

The above and other aspects, features and advantages of the present disclosure will become more apparent from the following description of certain exemplary embodiments, taken in conjunction with the accompanying drawings, in which:

FIG. 1 is a diagram illustrating a configuration example of an identification device according to the present disclosure;

FIG. 2 is a diagram for explaining an example of data indicating a time-series change in vibration intensity at a certain position on an optical fiber;

FIG. 3 is a diagram for explaining an example of data indicating the RMS of vibration intensity at each position on an optical fiber during the traveling of a train on each of tracks A and B;

FIG. 4 is a diagram for explaining an example of data indicating frequency intensity of vibration at a specific position on an optical fiber during the traveling of a train on each of tracks A and B;

FIG. 5 is a flowchart for explaining an example of an operation flow of the identification device according to the present disclosure;

FIG. 6 is a flowchart for explaining an example of an operation flow of the identification device according to the present disclosure;

FIG. 7 is a diagram illustrating a configuration example of an identification device according to the present disclosure;

FIG. 8 is a flowchart for explaining an example of an operation flow of the identification device according to the present disclosure;

FIG. 9 is a flowchart for explaining an example of an operation flow of the identification device according to the present disclosure;

FIG. 10 is a block diagram illustrating a configuration example of the identification device according to the present disclosure; and

FIG. 11 is a block diagram illustrating a hardware configuration example of a computer that implements the identification device according to the present disclosure.

### EXAMPLE EMBODIMENT

Hereinafter, example embodiments of the present disclosure will be described with reference to the drawings. The following description and drawings are omitted and simplified as appropriate for clarity of description. In the following drawings, the same elements will be denoted by the same reference signs, and redundant description will be omitted as necessary. Specific numerical values and the like shown below are merely examples for facilitating understanding of the present disclosure, and the present disclosure is not limited thereto.

### First example embodiment

First, a configuration example of an identification device 10 according to the present disclosure will be described.

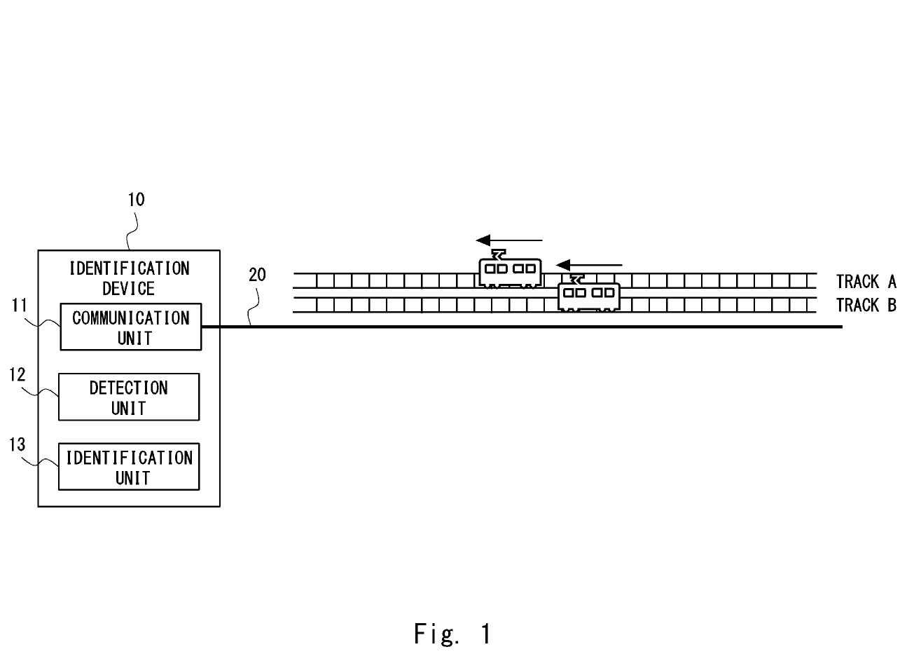

FIG. 1 is a diagram illustrating a configuration example of the identification device 10 according to the present disclosure.

As illustrated in FIG. 1, the identification device 10 includes a communication unit 11, a detection unit 12, and an identification unit 13. An optical fiber 20 is connected to the communication unit 11 of the identification device 10.

In the example of FIG. 1, the optical fiber 20 is laid along the two tracks A and B, in which the traveling directions of the trains are the same, in the vicinity of two tracks A and B. The number of tracks on which trains travel in the same traveling direction is not limited to two, and may be two or more. The optical fiber 20 may be laid overhead on a pole such as a utility pole or a steel tower, or may be buried in the ground. The optical fiber 20 may be laid in a mode of being included in the optical fiber cable.

The communication unit 11 and the detection unit 12 are achieved by, for example, a distributed acoustic sensing (DAS) device.

The communication unit 11 transmits pulsed light to the optical fiber 20, and receives, from the optical fiber 20, backscattered light generated as the pulsed light is transmitted through the optical fiber 20.

Here, in a case where vibrations are generated in the optical fiber 20, the characteristic (e.g., wavelength) of the backscattered light transmitted through the optical fiber 20 changes.

Therefore, the detection unit 12 can detect the vibration generated in the optical fiber 20 based on backscattered light received from the optical fiber 20 by the communication unit 11.

The detection unit 12 can identify a position where the backscattered light is generated, that is, a position where the vibration detected based on the backscattered light is generated (a distance of the optical fiber 20 from the communication unit 11) based on a time difference between a time at which the pulsed light is transmitted to the optical fiber 20 by the communication unit 11 and a time at which the backscattered light is received from the optical fiber 20 by the communication unit 11.

Therefore, the detection unit 12 can detect vibration at each position on the optical fiber 20.

Based on the vibration at each position on the optical fiber 20 detected by the detection unit 12, the identification unit 13 identifies the track on which the train is traveling among the tracks A and B, and identifies the traveling position of the train in the longitudinal direction of the identified track.

Hereinafter, the operations of the detection unit 12 and the identification unit 13 will be described in detail.

As described above, the detection unit 12 detects the vibration at each position on the optical fiber 20 based on the backscattered light received from the optical fiber 20. At this time, the detection unit 12 can calculate the vibration intensity based on the degree of change in the characteristic of the backscattered light.

Therefore, the detection unit 12 can detect the vibration intensity at each position on the optical fiber 20. The detection unit 12 can detect a time-series change in the vibration intensity at each position on the optical fiber 20.

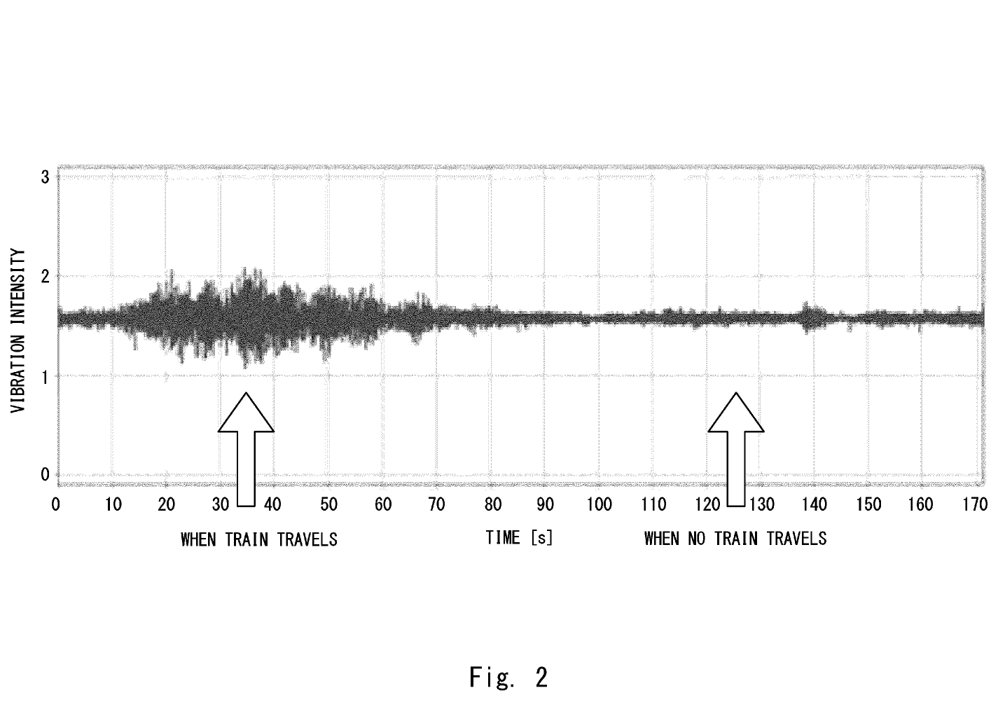

FIG. 2 is a diagram for explaining an example of data indicating a time-series change in vibration intensity at a certain position on the optical fiber 20. In FIG. 2, the horizontal axis represents time, and the vertical axis represents vibration intensity.

As illustrated in FIG. 2, in a case where the train is traveling in the vicinity of the optical fiber 20, vibration with a larger vibration intensity is generated than in a case where the train does not travel.

Therefore, the identification unit 13 identifies, as the traveling period of the train, a period in which vibration with a vibration intensity n (n is, for example, an integer of 2 or more) times or more the average vibration intensity in a case where the train is not traveling occurs.

At this time, for example, the identification unit 13 may identify, as the traveling period of the train, a period in which the above-described vibration has occurred at a plurality of arbitrary positions on the optical fiber 20.

After identifying the traveling period of the train, the identification unit 13 identifies the track on which the train is traveling among the tracks A and B by using, for example, one of the following two methods.

### (1) Method 1

In Method 1, after identifying the traveling period of the train, the identification unit 13 calculates the root mean square (RMS) of the vibration intensity at each position on the optical fiber 20 in the specified traveling period.

Here, the identification unit 13 holds in advance, for each of the tracks A and B, data indicating the RMS of the vibration intensity at each position on the optical fiber 20 in a case where the train has traveled on the track.

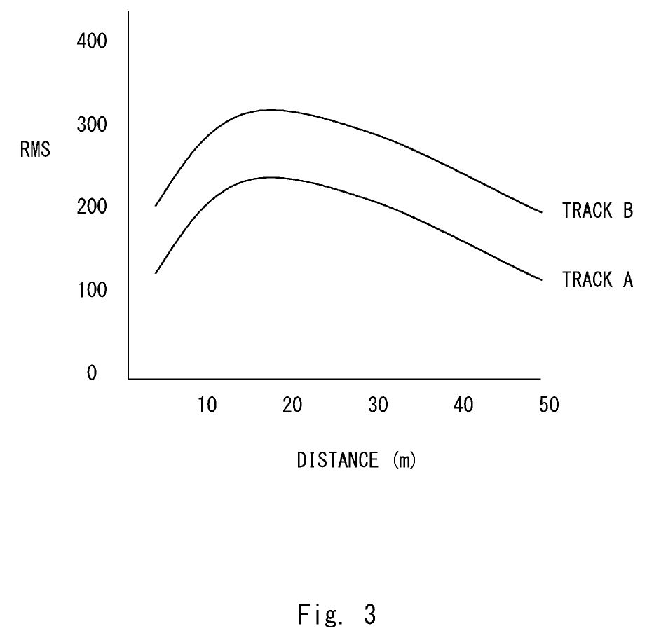

FIG. 3 is a diagram for explaining an example of data indicating the RMS of the vibration intensity at each position on the optical fiber 20 in a case where the train has traveled on each of the tracks A and B. In FIG. 3, the horizontal axis represents the distance of the optical fiber 20 from the communication unit 11, and the vertical axis represents RMS.

As illustrated in FIG. 3, since the track B is closer to the optical fiber 20 than the track A, the RMS value is larger as a whole than the track A.

Therefore, the identification unit 13 compares the RMS in the traveling period calculated above with the RMS in a case where a train travels on each of the tracks A and B held in advance, and identifies the track on which the train is traveling among the tracks A and B based on the comparison result. For example, the identification unit 13 identifies the track having a smaller difference from the waveform of the RMS in the traveling period calculated above among the tracks A and B as the track on which the train is traveling.

### (2) Method 2

In Method 2, after identifying the traveling period of the train, the identification unit 13 executes fast Fourier transformation (FFT) processing on data (for example, data as illustrated in FIG. 2) indicating a time-series change in the vibration intensity at a specific position on the optical fiber 20 in the specified traveling period, and calculates the frequency intensity of vibration at the specific position. The specific position on the optical fiber 20 may be, for example, a position where vibration having a vibration intensity of n times or more the average vibration intensity in a case where the train is not traveling is generated in a traveling period of the train.

Here, the identification unit 13 holds in advance, for each of the tracks A and B, data indicating the frequency intensity of vibration at a specific position on the optical fiber 20 in a case where the train has traveled on the track.

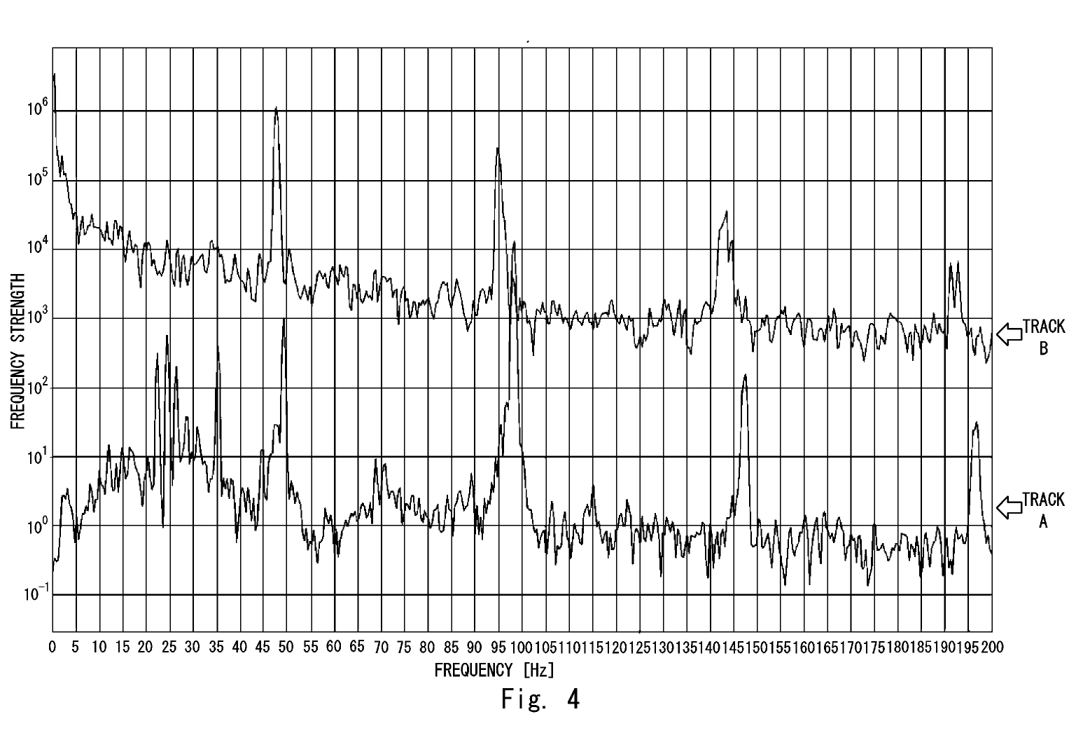

FIG. 4 is a diagram for explaining an example of data indicating frequency intensity of vibration at a specific position on the optical fiber 20 in a case where the train has traveled on each of the tracks A and B. In FIG. 4, the horizontal axis represents frequency, and the vertical axis represents frequency intensity.

As illustrated in FIG. 4, since the track B is closer to the optical fiber 20 than the track A, the value of the frequency intensity is larger as a whole than the track A.

Therefore, the identification unit 13 compares the frequency intensity during the traveling period calculated above with the frequency intensity in a case where the train travels on each of the tracks A and B held in advance, and identifies the track on which the train is traveling among the tracks A and B based on the comparison result. For example, the identification unit 13 identifies the track having a smaller difference from the waveform of the frequency intensity in the traveling period calculated above among the tracks A and B as the track on which the train is traveling.

The identification unit 13 identifies the traveling position of the train in the longitudinal direction of the identified track by using, for example, the following method.

The identification unit 13 refers to data (for example, data as illustrated in FIG. 2) indicating a time-series change in the vibration intensity at each position on the optical fiber 20. Here, for example, in a case where vibration with a vibration intensity of n times or more the average vibration intensity in a case where the train is not traveling occurs at a certain position on the optical fiber 20 at a certain time, it can be determined that the train is traveling at the position at that time.

Therefore, the identification unit 13 identifies the traveling position of the train in the longitudinal direction of the identified track based on the time-series change in the vibration intensity at each position on the optical fiber 20.

Subsequently, an operation flow of the identification device 10 according to the present disclosure will be described.

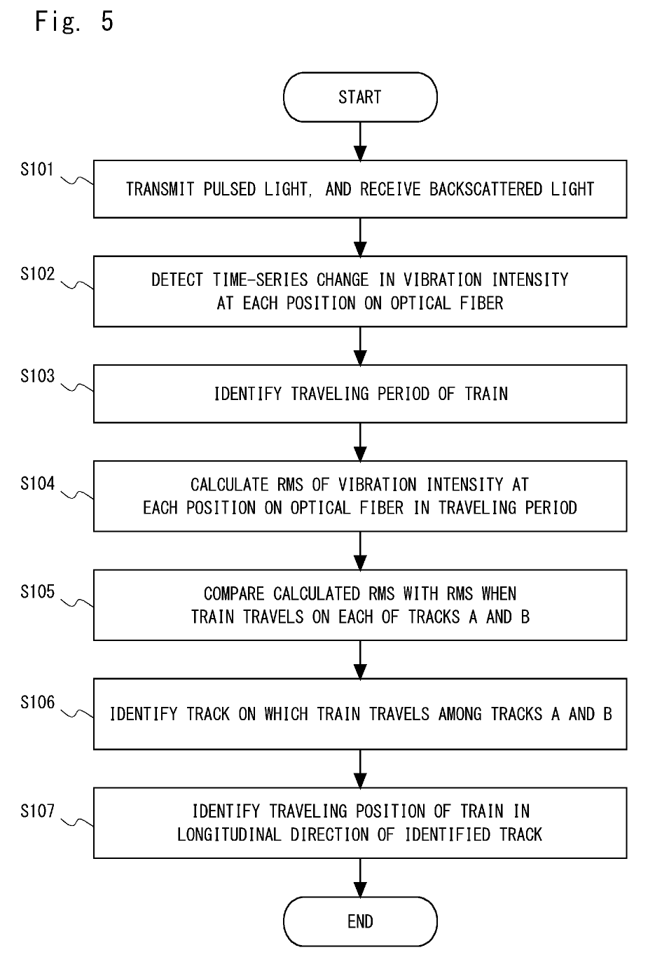

FIG. 5 is a flowchart for explaining an example of an operation flow of the identification device 10 according to the present disclosure. In the example of FIG. 5, it is assumed that the identification unit 13 identifies the track on which the train is traveling among the tracks A and B based on the RMS of the vibration intensity at each position on the optical fiber 20 in the traveling period as in the above-described Method 1. In the example of FIG. 5, it is assumed that the identification unit 13 holds in advance, for each of the tracks A and B, data indicating the RMS of the vibration intensity at each position on the optical fiber 20 in a case where the train has traveled on the track.

As illustrated in FIG. 5, first, the communication unit 11 transmits pulsed light to the optical fiber 20, and receives backscattered light generated as the pulsed light is transmitted through the optical fiber 20 from the optical fiber 20 (step S101).

Next, the detection unit 12 detects a time-series change in the vibration intensity at each position on the optical fiber 20 based on the backscattered light received from the optical fiber 20 (step S102).

Next, the identification unit 13 identifies the traveling period of the train based on the time-series change in the vibration intensity at each position on the optical fiber 20 (step S103).

Next, the identification unit 13 calculates the RMS of the vibration intensity at each position on the optical fiber 20 during the traveling period of the train (step S104).

Next, the identification unit 13 compares the RMS during the traveling period calculated in Step S104 with the RMS in a case where the train travels on each of the tracks A and B held in advance (Step S105).

Next, the identification unit 13 identifies the track on which the train is traveling among the tracks A and B based on the comparison result of step S105 (step S106).

Thereafter, the identification unit 13 identifies the traveling position of the train in the longitudinal direction of the track identified in step S106 based on the time-series change in the vibration intensity at each position on the optical fiber 20 (step S107).

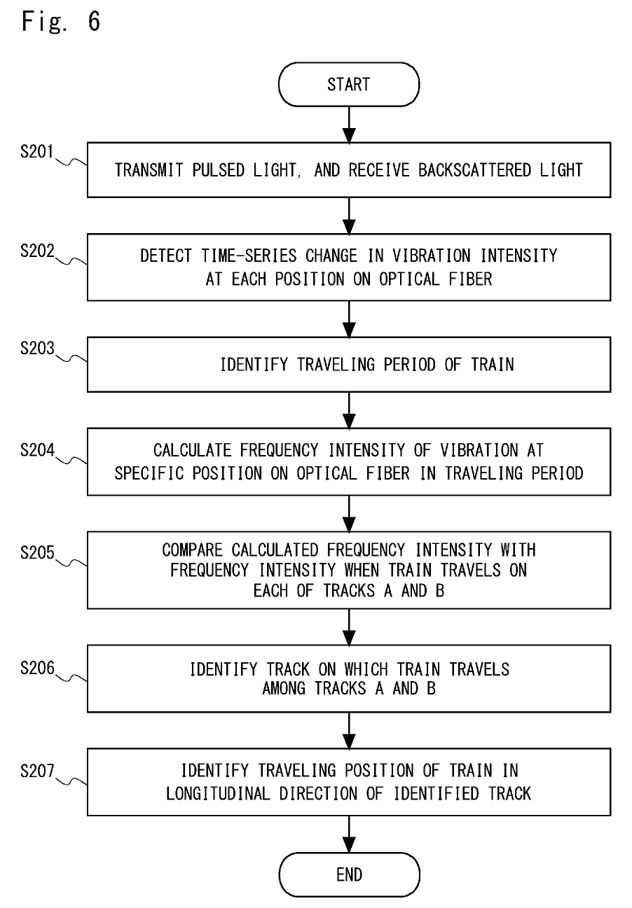

FIG. 6 is a flowchart for explaining an example of an operation flow of the identification device 10 according to the present disclosure. In the example of FIG. 6, the identification unit 13 identifies the track on which the train is traveling among the tracks A and B based on the frequency intensity of vibration at a specific position on the optical fiber 20 in the traveling period as in the above-described Method 2. In the example of FIG. 6, it is assumed that the identification unit 13 holds in advance, for each of the tracks A and B, data indicating the frequency intensity of vibration at a specific position on the optical fiber 20 in a case where a train has traveled on the track.

As illustrated in FIG. 6, first, the processing of steps S201 to S203 similar to steps S101 to S103 of FIG. 5 is performed.

Next, the identification unit 13 executes FFT processing on the data indicating the time-series change in the vibration intensity at the specific position on the optical fiber 20 during the traveling period of the train, and calculates the frequency intensity of vibration at the specific position (step S204).

Next, the identification unit 13 compares the frequency intensity during the traveling period calculated in step S204 with the frequency intensity in a case where the train travels on each of the tracks A and B held in advance (step S205).

Next, the identification unit 13 identifies the track on which the train is traveling among the tracks A and B based on the comparison result of step S205 (step S206).

Thereafter, processing in step S207 similar to step S107 in FIG. 5 is performed.

As described above, according to the first example embodiment, the communication unit 11 transmits pulsed light to the optical fiber 20, and receives, from the optical fiber 20, backscattered light generated as the pulsed light is transmitted through the optical fiber 20. The detection unit 12 detects the vibration at each position on the optical fiber 20 based on the backscattered light received from the optical fiber 20. Based on the vibration at each position on the optical fiber 20, the identification unit 13 identifies the track on which the train is traveling among the tracks A and B, and identifies the traveling position of the train in the longitudinal direction of the identified track.

Specifically, the identification unit 13 calculates the RMS of the vibration intensity during the traveling period of the train, compares the calculated RMS with the RMS in a case where the train travels on each of the tracks A and B held in advance, and identifies the track on which the train is traveling among the tracks A and B based on the comparison result. Alternatively, the identification unit 13 calculates the frequency intensity of vibration during the traveling period of the train, compares the calculated frequency intensity with the frequency intensity in a case where the train travels on each of the tracks A and B held in advance, and identifies the track on which the train is traveling among the tracks A and B based on the comparison result.

As a result, it is possible to specify the track on which the train is traveling among the tracks A and B on which the traveling directions of the trains are the same.

### Second example embodiment

First, a configuration example of an identification device 10X according to the present disclosure will be described.

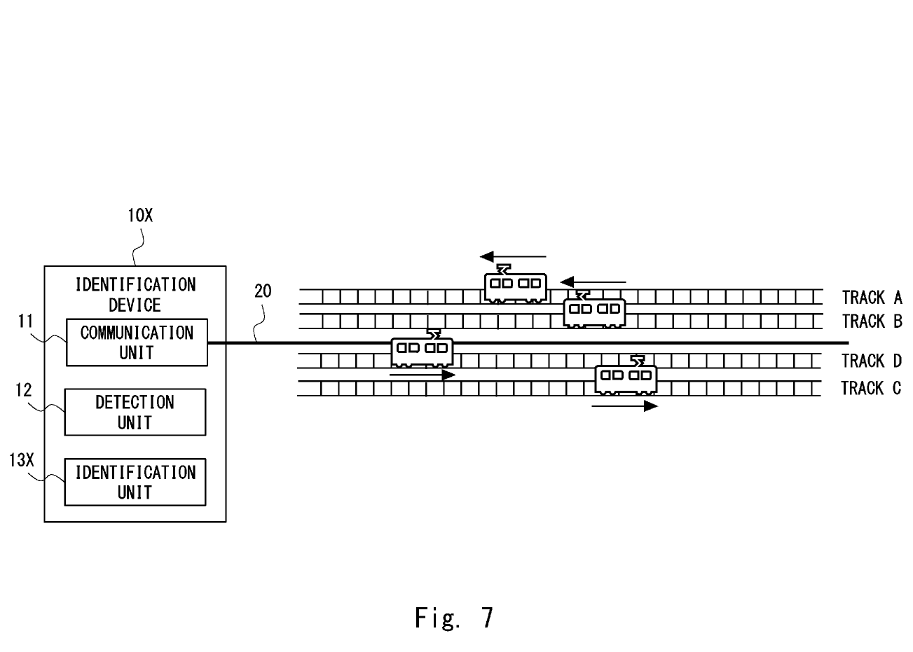

FIG. 7 is a diagram illustrating a configuration example of the identification device 10X according to the present disclosure.

As illustrated in FIG. 7, the identification device 10X is different from the identification device 10 illustrated in FIG. 1 in that the identification unit 13 is replaced with an identification unit 13X.

In the example of FIG. 7, the optical fiber 20 is laid along the four tracks A, B, C, and D constituting a quadruple track in the vicinity of the four tracks A, B, C, and D. Specifically, the traveling directions of the trains on the tracks A and B are the same (first direction. A leftward direction in the drawing), and the traveling directions of the trains on the tracks C and D are the same (a second direction opposite to the first direction. A rightward direction in the drawing). In the example of FIG. 7, the optical fiber 20 is laid between the tracks B and D, but the present disclosure is not limited thereto. For example, the optical fiber 20 may be laid on the side opposite to the track B side of the track A, or may be laid on the side opposite to the track D side of the track C.

Similarly to the identification unit 13, the identification unit 13X identifies the traveling period of the train based on the time-series change in the vibration intensity at each position on the optical fiber 20 detected by the detection unit 12.

After identifying the traveling period of the train, the identification unit 13X identifies the track on which the train is traveling among the tracks A, B, C, and D, for example, using one of the following two methods.

### (1) Method 1X

In Method 1X, after identifying the traveling period of the train, the identification unit 13X calculates the RMS of the vibration intensity at each position on the optical fiber 20 in the specified traveling period.

Next, the identification unit 13X identifies the traveling direction of the train.

For example, the identification unit 13X refers to data (for example, data as illustrated in FIG. 2) indicating a time-series change in the vibration intensity at each position on the optical fiber 20. Here, for example, it is assumed that, at a position P1 on the optical fiber 20 (a distance p1 of the optical fiber 20 from the communication unit 11), vibration with a vibration intensity n times or more the average vibration intensity in a case where the train is not traveling occurs. Thereafter, a position P2 on the optical fiber 20 (a distance p2 of the optical fiber 20 from the communication unit 11. Here, distance p2 > distance p1), vibration with a vibration intensity n times or more the average vibration intensity in a case where the train is not traveling occurs. In this case, it is possible to determine that the train travels in the same direction as the traveling direction of the trains on the tracks C and D (the second direction. The rightward direction in the drawing).

Therefore, the identification unit 13X identifies the traveling direction of the train based on the time-series change in the vibration intensity at each position on the optical fiber 20.

Here, the identification unit 13X holds in advance, for each of the tracks A and B, data (for example, data as illustrated in FIG. 3) indicating the RMS of the vibration intensity at each position on the optical fiber 20 in a case where the train has traveled on the track. The identification unit 13X holds in advance, for each of the tracks C and D, data (for example, data as illustrated in FIG. 3) indicating the RMS of the vibration intensity at each position on the optical fiber 20 in a case where the train has traveled on the track.

Therefore, in a case where the traveling direction of the train is the same as the traveling directions of the trains on the tracks A and B, the identification unit 13X compares the RMS in the traveling period calculated above with the RMS in a case where a train travels on each of the tracks A and B held in advance, and identifies the track on which the train is traveling among the tracks A and B based on the comparison result.

In a case where the traveling direction of the train is the same as the traveling directions of the trains on the tracks C and D, the identification unit 13X compares the RMS in the traveling period calculated above with the RMS in a case where a train travels on each of the tracks C and D held in advance, and identifies the track on which the train is traveling among the tracks C and D based on the comparison result.

### (2) Method 2X

In Method 2X, after identifying the traveling period of the train, the identification unit 13X executes FFT processing on data (for example, data as illustrated in FIG. 2) indicating a time-series change in the vibration intensity at a specific position on the optical fiber 20 in the specified traveling period, and calculates the frequency intensity of vibration at the specific position.

Next, the identification unit 13X identifies the traveling direction of the train based on the time-series change in the vibration intensity at each position on the optical fiber 20 by a method similar to Method 1X described above.

Here, the identification unit 13X holds in advance, for each of the tracks A and B, data (for example, data as illustrated in FIG. 4) indicating the frequency intensity of vibration at a specific position on the optical fiber 20 in a case where the train has traveled on the track. The identification unit 13X holds in advance, for each of the tracks C and D, data (for example, data as illustrated in FIG. 4) indicating the frequency intensity of vibration at a specific position on the optical fiber 20 in a case where the train has traveled on the track.

Therefore, in a case where the traveling direction of the train is the same as the traveling directions of the trains on the tracks A and B, the identification unit 13X compares the frequency intensity in the traveling period calculated above with the frequency intensity in a case where a train travels on each of the tracks A and B held in advance, and identifies the track on which the train is traveling among the tracks A and B based on the comparison result.

In a case where the traveling direction of the train is the same as the traveling directions of the trains on the tracks C and D, the identification unit 13X compares the frequency intensity in the traveling period calculated above with the frequency intensity in a case where a train travels on each of the tracks C and D held in advance, and identifies the track on which the train is traveling among the tracks C and D based on the comparison result.

In the identification unit 13X, the method of identifying the traveling position of the train in the longitudinal direction of the identified track may be a method similar to that in the identification unit 13. That is, the identification unit 13X may identify the traveling position of the train in the longitudinal direction of the identified track based on the time-series change in the vibration intensity at each position on the optical fiber 20 by a method similar to that in the identification unit 13.

Subsequently, an operation flow of the identification device 10X according to the present disclosure will be described.

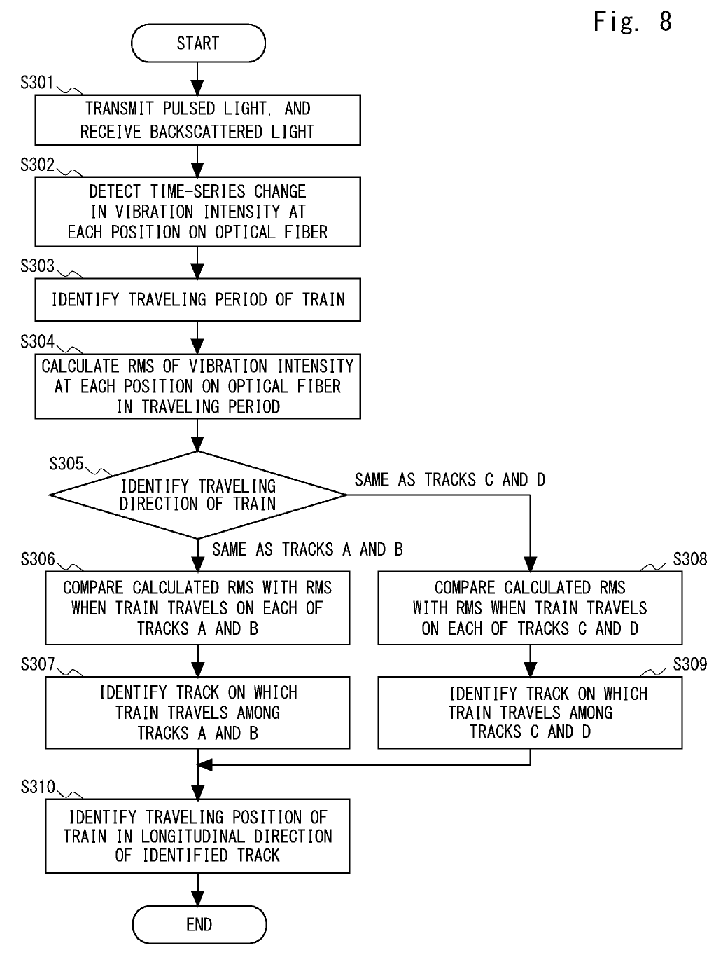

FIG. 8 is a flowchart for explaining an example of an operation flow of the identification device 10X according to the present disclosure. In the example of FIG. 8, it is assumed that the identification unit 13X identifies the track on which the train is traveling among the tracks A, B, C, and D based on the RMS of the vibration intensity at each position on the optical fiber 20 in the traveling period as in the above-described Method 1X. In the example of FIG. 8, it is assumed that the identification unit 13X holds in advance, for each of the tracks A and B, data indicating the RMS of the vibration intensity at each position on the optical fiber 20 in a case where the train has traveled on the track. It is assumed that the identification unit 13X holds in advance, for each of the tracks C and D, data indicating the RMS of the vibration intensity at each position on the optical fiber 20 in a case where the train has traveled on the track.

As illustrated in FIG. 8, first, the processing of steps S301 to S304 similar to steps S101 to S104 of FIG. 5 is performed.

Next, the identification unit 13X identifies the traveling direction of the train based on the time-series change in the vibration intensity at each position on the optical fiber 20 (step S305).

In a case where the traveling direction of the train identified in step S305 is the same as the traveling direction of the train on the tracks A and B, the identification unit 13X compares the RMS during the traveling period calculated in step S304 with the RMS in a case where the train travels on each of the tracks A and B held in advance (step S306). Next, the identification unit 13X identifies the track on which the train is traveling among the tracks A and B based on the comparison result of step S306 (step S307).

On the other hand, in a case where the traveling direction of the train identified in step S305 is the same as the traveling direction of the train on the tracks C and D, the identification unit 13X compares the RMS during the traveling period calculated in step S304 with the RMS in a case where the train travels on each of the tracks C and D held in advance (step S308). Next, the identification unit 13X identifies the track on which the train is traveling among the tracks C and D based on the comparison result of step S308 (step S309).

Thereafter, processing in step S310 similar to step S107 in FIG. 5 is performed.

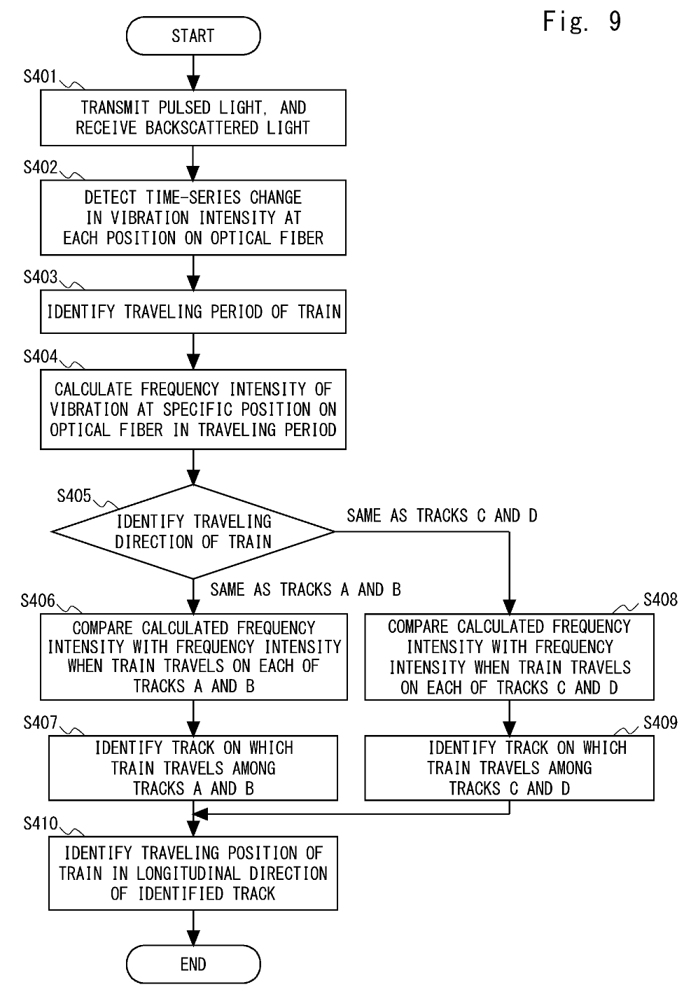

FIG. 9 is a flowchart for explaining an example of an operation flow of the identification device 10X according to the present disclosure. In the example of FIG. 9, the identification unit 13X identifies the track on which the train is traveling among the tracks A, B, C, and D based on the frequency intensity of vibration at a specific position on the optical fiber 20 in the traveling period as in the above-described Method 2X. In the example of FIG. 9, it is assumed that the identification unit 13X holds in advance, for each of the tracks A and B, data indicating the frequency intensity of vibration at a specific position on the optical fiber 20 in a case where a train has traveled on the track. It is assumed that the identification unit 13X holds in advance, for each of the tracks C and D, data indicating the frequency intensity of vibration at a specific position on the optical fiber 20 in a case where a train has traveled on the track.

As illustrated in FIG. 9, first, the processing of steps S401 to S404 similar to steps S201 to S204 of FIG. 6 is performed.

Next, the identification unit 13X identifies the traveling direction of the train based on the time-series change in the vibration intensity at each position on the optical fiber 20 (step S405).

In a case where the traveling direction of the train identified in step S405 is the same as the traveling direction of the train on the tracks A and B, the identification unit 13X compares the frequency intensity during the traveling period calculated in step S404 with the frequency intensity in a case where the train travels on each of the tracks A and B held in advance (step S406). Next, the identification unit 13X identifies the track on which the train is traveling among the tracks A and B based on the comparison result of step S406 (step S407).

On the other hand, in a case where the traveling direction of the train identified in step S405 is the same as the traveling direction of the train on the tracks C and D, the identification unit 13X compares the frequency intensity during the traveling period calculated in step S404 with the frequency intensity in a case where the train travels on each of the tracks C and D held in advance (step S408). Next, the identification unit 13X identifies the track on which the train is traveling among the tracks C and D based on the comparison result of step S408 (step S409).

Thereafter, processing in steps S410 similar to steps S207 in FIG. 6 is performed.

As described above, according to the second example embodiment, the identification unit 13X calculates the RMS of the vibration intensity during the traveling period of the train and identifies the traveling direction of the train. Here, in a case where the traveling direction of the train is the same as the traveling directions of the trains on the tracks A and B, the identification unit 13X compares the RMS in the traveling period calculated above with the RMS in a case where a train travels on each of the tracks A and B held in advance, and identifies the track on which the train is traveling among the tracks A and B based on the comparison result. On the other hand, in a case where the traveling direction of the train is the same as the traveling directions of the trains on the tracks C and D, the identification unit 13X compares the RMS in the traveling period calculated above with the RMS in a case where a train travels on each of the tracks C and D held in advance, and identifies the track on which the train is traveling among the tracks C and D based on the comparison result.

Alternatively, the identification unit 13X calculates the frequency intensity of vibration in the traveling period of the train and identifies the traveling direction of the train. Here, in a case where the traveling direction of the train is the same as the traveling directions of the trains on the tracks A and B, the identification unit 13X compares the frequency intensity in the traveling period calculated above with the frequency intensity in a case where a train travels on each of the tracks A and B held in advance, and identifies the track on which the train is traveling among the tracks A and B based on the comparison result. On the other hand, in a case where the traveling direction of the train is the same as the traveling directions of the trains on the tracks C and D, the identification unit 13X compares the frequency intensity in the traveling period calculated above with the frequency intensity in a case where a train travels on each of the tracks C and D held in advance, and identifies the track on which the train is traveling among the tracks C and D based on the comparison result.

As a result, even in a case where the form of the track is a quadruple track, it is possible to identify the track on which the train is traveling among the tracks A, B, C, and D constituting the quadruple track.

### Third example embodiment

The present third example embodiment is associated with an example embodiment that generalizes the first and second example embodiments described above.

FIG. 10 is a block diagram illustrating a configuration example of an identification device 10Y according to the present disclosure.

As illustrated in FIG. 10, the identification device 10Y includes a reception unit 11Y, a detection unit 12Y, and an identification unit 13Y.

The reception unit 11Y receives backscattered light from the optical fiber 20 laid in the vicinity of the plurality of first tracks along the plurality of first tracks in which the traveling direction of the train is a first direction. The plurality of first tracks is relevant to, for example, the tracks A and B described above.

The detection unit 12Y detects the vibration at each position on the optical fiber 20 based on the backscattered light.

The identification unit 13Y identifies the first track on which the train is traveling among the plurality of first tracks based on the vibration at each position on the optical fiber 20.

As a result, it is possible to identify the first track on which the train is traveling among the plurality of first tracks on which the traveling directions of the trains are the same first direction.

The detection unit 12Y may detect a time-series change in the vibration intensity at each position on the optical fiber 20. The identification unit 13Y may identify the traveling period during which the train has traveled in the vicinity of the optical fiber 20 based on the time-series change in the vibration intensity at each position on the optical fiber 20. The identification unit 13Y may calculate the RMS of the vibration intensity at each position on the optical fiber 20 in the traveling period. The identification unit 13Y may identify the first track on which the train is traveling among the plurality of first tracks based on the calculated RMS.

The identification unit 13Y may hold in advance, for each of the plurality of first tracks, the RMS in a case where the train has traveled on the first track. The identification unit 13Y may identify the first track on which the train is traveling among the plurality of first tracks based on the calculated RMS and the RMS in a case where the train travels on each of the plurality of first tracks held in advance.

The optical fiber 20 may be laid in the vicinity of the plurality of first tracks along the plurality of first tracks, and may be laid in the vicinity of the plurality of second tracks along the plurality of second tracks in which the traveling direction of the train is the second direction opposite to the first direction. The plurality of second tracks are relevant to, for example, the tracks C and D described above. The identification unit 13Y may hold in advance the RMS in a case where the train has traveled on the first track for each of the plurality of first tracks, and hold in advance the RMS in a case where the train has traveled on the second track for each of the plurality of second tracks. The identification unit 13Y may identify the traveling direction of the train traveling in the vicinity of the optical fiber 20 based on the time-series change in the vibration intensity at each position on the optical fiber 20. In a case where the specified traveling direction is the first direction, the identification unit 13Y may identify the first track on which the train is traveling among the plurality of first tracks based on the calculated RMS and the RMS in a case where the train travels on each of the plurality of first tracks held in advance. In a case where the specified traveling direction is the second direction, the identification unit 13Y may identify the second track on which the train is traveling among the plurality of second tracks based on the calculated RMS and the RMS in a case where the train travels on each of the plurality of second tracks held in advance.

The detection unit 12Y may detect a time-series change in the vibration intensity at each position on the optical fiber 20. The identification unit 13Y may identify the traveling period during which the train has traveled in the vicinity of the optical fiber 20 based on the time-series change in the vibration intensity at each position on the optical fiber 20. The identification unit 13Y may calculate the frequency intensity of vibration at a specific position by performing Fourier transformation on data indicating a time-series change in the vibration intensity at the specific position on the optical fiber 20 in the traveling period. The identification unit 13Y may identify the first track on which the train is traveling among the plurality of first tracks based on the calculated frequency intensity.

The identification unit 13Y may hold in advance, for each of the plurality of first tracks, the frequency intensity in a case where the train has traveled on the first track. The identification unit 13Y may identify the first track on which the train is traveling among the plurality of first tracks based on the calculated frequency intensity and the frequency intensity in a case where the train travels on each of the plurality of first tracks held in advance.

The optical fiber 20 may be laid in the vicinity of the plurality of first tracks along the plurality of first tracks, and may be laid in the vicinity of the plurality of second tracks along the plurality of second tracks in which the traveling direction of the train is the second direction opposite to the first direction. The plurality of second tracks are relevant to, for example, the tracks C and D described above. The identification unit 13Y may hold in advance the frequency intensity in a case where the train has traveled on the first track for each of the plurality of first tracks, and hold in advance the frequency intensity in a case where the train has traveled on the second track for each of the plurality of second tracks. The identification unit 13Y may identify the traveling direction of the train traveling in the vicinity of the optical fiber 20 based on the time-series change in the vibration intensity at each position on the optical fiber 20. In a case where the specified traveling direction is the first direction, the identification unit 13Y may identify the first track on which the train is traveling among the plurality of first tracks based on the calculated frequency intensity and the frequency intensity in a case where the train travels on each of the plurality of first tracks held in advance. In a case where the specified traveling direction is the second direction, the identification unit 13Y may identify the second track on which the train is traveling among the plurality of second tracks based on the calculated frequency intensity and the frequency intensity in a case where the train travels on each of the plurality of second tracks held in advance.

The detection unit 12Y may detect a time-series change in the vibration intensity at each position on the optical fiber 20. The identification unit 13Y may identify the traveling position of the train in the longitudinal direction of the specified first track based on the time-series change in the vibration intensity at each position on the optical fiber 20.

### Hardware configuration of identification device

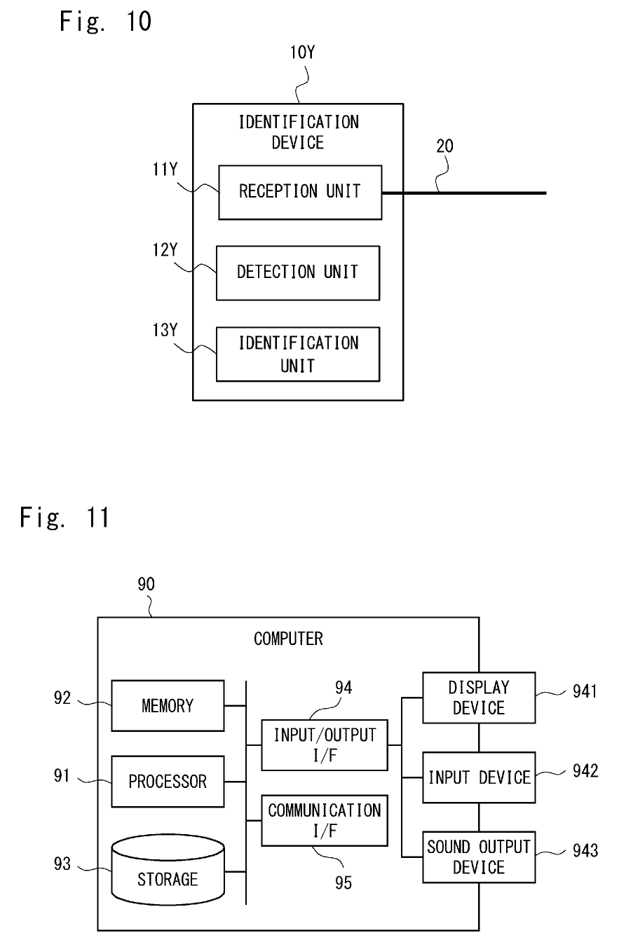

FIG. 11 is a block diagram illustrating a hardware configuration example of a computer 90 that implements the identification devices 10, 10X, and 10Y according to the present disclosure.

As illustrated in FIG. 11, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is an arithmetic processing device such as a central processing unit (CPU) or a graphics processing unit (GPU). The memory 92 is a memory such as a random access memory (RAM) or a read only memory (ROM). The storage 93 is, for example, a storage device such as a hard disk drive (HDD), a solid state drive (SSD), or a memory card. The storage 93 may be a memory such as a RAM or a ROM.

A program is stored in the storage 93. This program includes commands (or software code) for causing the computer 90 to perform one or more functions in the above-described identification devices 10, 10X, and 10Y in a case where being read by the computer. The components in the above-described identification devices 10, 10X, and 10Y may be implemented by the processor 91 reading and executing a program stored in the storage 93. A storage function in the above-described identification devices 10, 10X, and 10Y may be achieved by the memory 92 or the storage 93.

Further, the above-described program may be stored in a non-transitory computer-readable medium or a tangible storage medium. As an example and not by way of limitation, the computer-readable medium or the tangible storage medium includes a RAM, a ROM, a flash memory, an SSD or another memory technology, a compact disc (CD)-ROM, a digital versatile disc (DVD), a Blu-ray (registered trademark) disk or another optical disk storage, a magnetic cassette, a magnetic tape, a magnetic disk storage, or another magnetic storage device. The program may be transmitted on a transitory computer-readable medium or a communication medium. As an example and not by way of limitation, the transitory computer-readable medium or the communication medium includes an electrical signal, an optical signal, an acoustic signal, or another form of propagation signal.

The input/output interface 94 is connected to a display device 941, an input device 942, a sound output device 943, or the like. The display device 941 is a device that displays a screen relevant to depiction data processed by the processor 91, such as a liquid crystal display (LCD), a cathode ray tube (CRT) display, or a monitor. The input device 942 is a device that receives an input of an operation performed by an operator, and is, for example, a keyboard, a mouse, or a touch sensor. The display device 941 and the input device 942 may be integrated, and may be implemented as a touch panel. The sound output device 943 is a device that acoustically outputs a sound associated with acoustic data processed by the processor 91, such as a speaker.

The communication interface 95 transmits and receives data to and from an external device. For example, the communication interface 95 communicates with an external device via a wired communication path or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### Supplementary Note 1

An identification device including:

at least one memory that stores instructions; and

at least one processor configured to execute the instructions to:

receive backscattered light from an optical fiber laid in a vicinity of a plurality of first tracks along the plurality of first tracks in which a traveling direction of a train is a first direction;

detect vibration at each position on the optical fiber based on the backscattered light; and

identify, among the plurality of first tracks, a first track on which a train is traveling based on vibration at each position on the optical fiber.

### Supplementary Note 2

The identification device according to Supplementary Note 1, in which the at least one processor is configured to execute the instructions to:

detect a time-series change in vibration intensity at each position on the optical fiber;

identify a traveling period during which a train has traveled in a vicinity of the optical fiber based on the time-series change in vibration intensity at each position on the optical fiber;

calculate a root mean square (RMS) of vibration intensity at each position on the optical fiber in the traveling period; and

identify, among the plurality of first tracks, a first track on which the train is traveling based on the calculated RMS.

### Supplementary Note 3

The identification device according to Supplementary Note 2, in which the at least one processor is configured to execute the instructions to: hold, for each of the plurality of first tracks, in advance, the RMS during a train has traveled on the first track; and

identify, among the plurality of first tracks, a first track on which a train is traveling based on the calculated RMS and the RMS during train traveling on each of the plurality of first tracks held in advance.

### Supplementary Note 4

The identification device according to Supplementary Note 2, in which the optical fiber is laid in a vicinity of the plurality of first tracks along the plurality of first tracks and is laid in a vicinity of a plurality of second tracks along the plurality of second tracks in which a traveling direction of a train is a second direction opposite to the first direction, and

the at least one processor is configured to execute the instructions to: hold, for each of the plurality of first tracks, in advance, the RMS during the train has traveled on the first track;

hold, for each of the plurality of second tracks, in advance, the RMS during the train has traveled on the second track;

identify a traveling direction of the train traveling in a vicinity of the optical fiber based on a time-series change in vibration intensity at each position on the optical fiber;

identify, in a case where the specified traveling direction is the first direction, a first track on which the train is traveling among the plurality of first tracks based on the calculated RMS and the RMS during train traveling on each of the plurality of first tracks held in advance; and

identify, in a case where the specified traveling direction is the second direction, a second track on which the train is traveling among the plurality of second tracks based on the calculated RMS and the RMS during train traveling on each of the plurality of second tracks held in advance.

### Supplementary Note 5

The identification device according to Supplementary Note 1, in which the at least one processor is configured to execute the instructions to: detect a time-series change in vibration intensity at each position on the optical fiber;

identify a traveling period during which a train has traveled in a vicinity of the optical fiber based on a time-series change in vibration intensity at each position on the optical fiber; perform Fourier transformation on data indicating a time-series change in vibration intensity at a specific position on the optical fiber in the traveling period to calculate a frequency intensity of vibration at the specific position; and

identify, among the plurality of first tracks, a first track on which the train is traveling based on the calculated frequency intensity.

### Supplementary Note 6

The identification device according to Supplementary Note 5, in which the at least one processor is configured to execute the instructions to:

hold, for each of the plurality of first tracks, in advance, the frequency intensity during a train has traveled on the first track; and

identify, among the plurality of first tracks, a first track on which a train is traveling based on the calculated frequency intensity and the frequency intensity during train traveling on each of the plurality of first tracks held in advance.

### Supplementary Note 7

The identification device according to Supplementary Note 5, in which

the optical fiber is laid in a vicinity of the plurality of first tracks along the plurality of first tracks and is laid in a vicinity of a plurality of second tracks along the plurality of second tracks in which a traveling direction of a train is a second direction opposite to the first direction, and

the at least one processor is configured to execute the instructions to:

hold, for each of the plurality of first tracks, in advance, the frequency intensity during the train has traveled on the first track;

hold, for each of the plurality of second tracks, in advance, the frequency intensity during the train has traveled on the second track; identify a traveling direction of the train traveling in a vicinity of the optical fiber based on a time-series change in vibration intensity at each position on the optical fiber;

identify, in a case where the specified traveling direction is the first direction, a first track on which the train is traveling among the plurality of first tracks based on the calculated frequency intensity and the frequency intensity during train traveling on each of the plurality of first tracks held in advance; and

identify, in a case where the specified traveling direction is the second direction, a second track on which the train is traveling among the plurality of second tracks based on the calculated frequency intensity and the frequency intensity during train traveling on each of the plurality of second tracks held in advance.

### Supplementary Note 8

The identification device according to Supplementary Note 1, in which the at least one processor is configured to execute the instructions to:

detect a time-series change in vibration intensity at each position on the optical fiber; and

identify a traveling position of a train in a longitudinal direction of the identified first track based on the time-series change in vibration intensity at each position on the optical fiber.

### Supplementary Note 9

An identification method executed by an identification device, the method including:

receiving backscattered light from an optical fiber laid in a vicinity of a plurality of first tracks along the plurality of first tracks in which a traveling direction of a train is a first direction;

detecting vibration at each position on the optical fiber based on the backscattered light; and

identifying, among the plurality of first tracks, a first track on which a train is traveling based on vibration at each position on the optical fiber.

### Supplementary Note 10

A non-transitory computer-readable medium having stored therein a program for causing a computer to execute:

a step of receiving backscattered light from an optical fiber laid in a vicinity of a plurality of first tracks along the plurality of first tracks in which a traveling direction of a train is a first direction;

a step of detecting vibration at each position on the optical fiber based on the backscattered light; and

a step of identifying, among the plurality of first tracks, a first track on which a train is traveling based on vibration at each position on the optical fiber.

Note that, some or all of elements (e.g., structures and functions) specified in Supplementary Notes 2 to 8 dependent on Supplementary Note 1 may also be dependent on Supplementary Note 9 and Supplementary Note 10 in dependency similar to that of Supplementary Notes 2 to 8 dependent on Supplementary Note 1. Some or all of elements specified in any of Supplementary Notes may be applied to various types of hardware, software, and recording means for recording software, systems, and methods.

What is claimed is:

1. An identification device comprising:
at least one memory that stores instructions; and
at least one processor configured to execute the instructions to:
receive backscattered light from an optical fiber laid in a vicinity of a plurality of first tracks along the plurality of first tracks in which a traveling direction of a train is a first direction;
detect vibration at each position on the optical fiber based on the backscattered light; and
identify, among the plurality of first tracks, a first track on which a train is traveling based on vibration at each position on the optical fiber.

2. The identification device according to claim 1, wherein the at least one processor is configured to execute the instructions to:
detect a time-series change in vibration intensity at each position on the optical fiber;
identify a traveling period during which a train has traveled in a vicinity of the optical fiber based on the time-series change in vibration intensity at each position on the optical fiber;
calculate a root mean square (RMS) of vibration intensity at each position on the optical fiber in the traveling period; and
identify, among the plurality of first tracks, a first track on which the train is traveling based on the calculated RMS.

3. The identification device according to claim 2, wherein the at least one processor is configured to execute the instructions to:
hold, for each of the plurality of first tracks, in advance, the RMS during a train has traveled on the first track; and
identify, among the plurality of first tracks, a first track on which a train is traveling based on the calculated RMS and the RMS during train traveling on each of the plurality of first tracks held in advance.

4. The identification device according to claim 2, wherein
the optical fiber is laid in a vicinity of the plurality of first tracks along the plurality of first tracks and is laid in a vicinity of a plurality of second tracks along the plurality of second tracks in which a traveling direction of a train is a second direction opposite to the first direction, and
the at least one processor is configured to execute the instructions to:
hold, for each of the plurality of first tracks, in advance, the RMS during the train has traveled on the first track;
hold, for each of the plurality of second tracks, in advance, the RMS during the train has traveled on the second track;
identify a traveling direction of the train traveling in a vicinity of the optical fiber based on a time-series change in vibration intensity at each position on the optical fiber;
identify, in a case where the specified traveling direction is the first direction, a first track on which the train is traveling among the plurality of first tracks based on the calculated RMS and the RMS during train traveling on each of the plurality of first tracks held in advance; and
identify, in a case where the specified traveling direction is the second direction, a second track on which the train is traveling among the plurality of second tracks based on the calculated RMS and the RMS during train traveling on each of the plurality of second tracks held in advance.

5. The identification device according to claim 1, wherein the at least one processor is configured to execute the instructions to:
detect a time-series change in vibration intensity at each position on the optical fiber;
identify a traveling period during which a train has traveled in a vicinity of the optical fiber based on a time-series change in vibration intensity at each position on the optical fiber;
perform Fourier transformation on data indicating a time-series change in vibration intensity at a specific position on the optical fiber in the traveling period to calculate a frequency intensity of vibration at the specific position; and
identify, among the plurality of first tracks, a first track on which the train is traveling based on the calculated frequency intensity.

6. The identification device according to claim 5, wherein the at least one processor is configured to execute the instructions to:
hold, for each of the plurality of first tracks, in advance, the frequency intensity during a train has traveled on the first track; and
identify, among the plurality of first tracks, a first track on which a train is traveling based on the calculated frequency intensity and the frequency intensity during train traveling on each of the plurality of first tracks held in advance.

7. The identification device according to claim 5, wherein
the optical fiber is laid in a vicinity of the plurality of first tracks along the plurality of first tracks and is laid in a vicinity of a plurality of second tracks along the plurality of second tracks in which a traveling direction of a train is a second direction opposite to the first direction, and
the at least one processor is configured to execute the instructions to:
hold, for each of the plurality of first tracks, in advance, the frequency intensity during the train has traveled on the first track;
hold, for each of the plurality of second tracks, in advance, the frequency intensity during the train has traveled on the second track;
identify a traveling direction of the train traveling in a vicinity of the optical fiber based on a time-series change in vibration intensity at each position on the optical fiber;
identify, in a case where the specified traveling direction is the first direction, a first track on which the train is traveling among the plurality of first tracks based on the calculated frequency intensity and the frequency intensity during train traveling on each of the plurality of first tracks held in advance; and
identify, in a case where the specified traveling direction is the second direction, a second track on which the train is traveling among the plurality of second tracks based on the calculated frequency intensity and the frequency intensity during train traveling on each of the plurality of second tracks held in advance.

8. The identification device according to claim 1, wherein the at least one processor is configured to execute the instructions to:
detect a time-series change in vibration intensity at each position on the optical fiber; and
identify a traveling position of a train in a longitudinal direction of the identified first track based on the time-series change in vibration intensity at each position on the optical fiber.

9. An identification method executed by an identification device, the method comprising:
receiving backscattered light from an optical fiber laid in a vicinity of a plurality of first tracks along the plurality of first tracks in which a traveling direction of a train is a first direction;
detecting vibration at each position on the optical fiber based on the backscattered light; and
identifying, among the plurality of first tracks, a first track on which a train is traveling based on vibration at each position on the optical fiber.

10. A non-transitory computer-readable medium having stored therein a program for causing a computer to execute:
a step of receiving backscattered light from an optical fiber laid in a vicinity of a plurality of first tracks along the plurality of first tracks in which a traveling direction of a train is a first direction;
a step of detecting vibration at each position on the optical fiber based on the backscattered light; and
a step of identifying, among the plurality of first tracks, a first track on which a train is traveling based on vibration at each position on the optical fiber.
